(19) United States
(12) Patent Application Publication
(10) Pub. No.: US 2015/0275674 A1
(43) Pub. Date: Oct. 1, 2015

(54) GAS TURBINE ROTOR

(71) Applicant: INDUSTRIA DE TURBO PROPULSORES, S.A., Zamudio (Vizcaya) (ES)

(72) Inventor: Jose Javier ALVAREZ GARCIA, Madrid (ES)

(21) Appl. No.: 14/668,310

(22) Filed: Mar. 25, 2015

(30) Foreign Application Priority Data
Mar. 25, 2014 (EP) 14382102.3

(51) Int. Cl. F01D 5/08; F01D 5/06; F01D 5/02

(52) U.S. Cl. CPC F01D 5/084; F01D 5/022; F01D 5/06; F05D 2240/24; F05D 2260/20

(57) ABSTRACT

Gas turbine rotor in which flow from the turbine internal cavity is directed through slots (45) in the connecting flanges (52-53) of adjacent rotor rows to a cooling flow passage (43) of a heat shield (60) controlled by flow restrictors (82). A portion of such flow is directed to bucket grooves (34) beneath the blade attachments (25B), thereby cooling the disc rim (32), and controlled by flow restrictors (80). The remaining flow is exhausted through a heat shield rim gap (81) thereby cooling the front disc rim (32) and the blade shank cavity (25A).

### CROSS REFERENCE TO RELATED APPLICATION

This application claims the priority of European Patent Application No. 14382102.3 filed on Mar. 25, 2014, the contents of which are incorporated herein by reference.

### FIELD OF THE INVENTION

The present invention relates to a gas turbine engine and specifically to a turbine rotor having a sealing member for shielding and cooling the rotor disc faces and drive arms with dedicated cooler air bled from some engine compressor stage.

### PRIOR ART

It is well known that the efficiency and output of a gas turbine engine can be increased by increasing the operating temperature of the turbine. Nevertheless, as a practical matter, the turbine operating temperature is limited by the high temperature capabilities of turbine elements. Some increase in efficiency and output has been obtained by the development and use of new materials capable of withstanding higher temperatures. Even these new materials are not, however, generally capable of withstanding the extremely high temperature desired in modern gas turbines. Consequently, various heat shield arrangements have been used for maintaining the structural elements of the turbine at temperatures at which their materials have adequate strength to resist loads imposed during operation. These heat shield arrangements are used to shield the rotor discs and the interconnecting rotor structure from the high temperature combustion products driving the turbine and to direct cooling air to the structural elements. The following documents may be cited as antecedents: U.S. Pat. No. 3,056,579A, U.S. Pat. No. 3,343,806A, U.S. Pat. No. 4,088,422A, U.S. Pat. No. 4,526,508A, U.S. Pat. No. 4,730,982A, U.S. Pat. No. 5,816,776A, U.S. Pat. No. 6,283,712B1, U.S. Pat. No. 6,655,920B2, US2002187046A1, US2012060507A1 y US2013039760A1. This cooling is generally accomplished by means of pressurised air bled from the compressor. Since engine performance is reduced by cooling air off-take, it is imperative that the cooling air is used effectively, lest the decrease in efficiency caused by extraction of the air is greater than the increase resulting from the higher turbine operating temperature. This means that such heat shield arrangements must be efficient from the standpoint of minimizing the quantity of cooling air required to cool satisfactory the structural elements.

The complexity of the geometry of the heat shield and disc elements and the broad range of temperatures and temperature gradients involved in the environment surrounding these elements make sealing difficult to achieve. Classical heat shield arrangements rely on achieving an effective sealing of the cooling passage formed between the heat shield and the disc. Cooling performance is very sensitive to the area of this leakage as an increase in leakage flow implies a reduction in available cooling flow.

### BRIEF SUMMARY OF THE INVENTION

A turbine section of a gas turbine engine includes stator and rotor rows. Each rotor row has a plurality of blades connected to a rotor disc at blade attachments. Each stator row has a plurality of vanes attached to a seal carrier which supports an abradable seal land. The rotor disc includes drive arms which typically extend forward and rearward from the disc and include connecting flanges at their edge.

A heat shield includes a connecting flange in its front section attached to adjacent disc flanges and has at least one knife edge member to form a labyrinth seal with the stator seal land. The heat shield extends rearward from the flange region to surround the shape of the disc and the disc drive arm but leaving a predetermined annular space between the heat shield and the disc or disc drive arm which defines the heat shield cooling flow passage.

In a preferred embodiment of the present application, the disc cooling flow from the turbine internal cavity is directed to recessions in the connecting flanges which communicate the internal turbine cavity with the heat shield cooling flow passage. The disc cooling flow protects the disc and the front disc drive arm against hot gas ingestion from the main engine gas path. The amount of disc cooling flow is controlled in the preferred embodiment by slots in the heat shield spigot along the heat shield cooling flow passage, which act as heat shield flow restrictors.

A portion of the disc cooling flow is directed to bucket grooves beneath each of the blade roots in the blade attachment region, thereby cooling disc rim, and is controlled in the preferred embodiment by orifices in blade retention lock plates situated at the end of such bucket grooves, which act as bucket groove flow restrictors.

The remaining portion of the disc cooling flow is exhausted through a rim gap formed by the heat shield rim edge and the disc front face thereby cooling the disc rim front face and the blade shank cavity over the disc outer radius.

The area of the rim gap is set at least three times larger than the area of the heat shield flow restrictors and also than the area of the lock plate discharge orifices which implies the pressure in the rim cavity is practically the same as the pressure in the external cavity at the exit of the rim and that variations in rim gap area will not affect either disc cooling flow or bucket groove cooling flow.

The area of the heat shield flow restrictors is set to provide a predetermined larger amount of flow than the area of the bucket groove flow restrictors, considering the worst combination of extremes of restrictor area tolerances which consists in minimum tolerance area of heat shield flow restrictors and maximum tolerance area of bucket groove flow restrictors. This combination ensures rim gap cooling outflow at all times preventing hot gas ingestion into the heat shield cooling flow passage.

### BRIEF DESCRIPTION OF THE DRAWINGS

FIG. 1 is a schematic cross-sectional view of an axial flow gas turbine engine.

FIG. 2 is a schematic cross-sectional view of a portion of a turbine section of an axial flow gas turbine engine including one turbine stage and a heat shield of the invention.

FIG. 3 is an exploded perspective view of a circumferential portion of the heat shield and two adjacent disc flanges illustrating a cooling feed through a flow non-restrictive large area recession in the heat shield flange and heat shield cooling flow restrictors situated in the heat shield rear extension.

FIG. 4 is an exploded perspective view of an alternative embodiment to that shown in FIG. 3 illustrating a cooling feed through heat shield flow restrictors situated in the heat shield flange and a flow non-restrictive large area slot in the heat shield rear extension.

FIG. 5 is an exploded perspective view of an alternative embodiment to that shown in FIG. 3 illustrating a cooling feed through heat shield flow restrictors situated in the rear disc flange and a flow non-restrictive large area slot in the heat shield rear extension.

In these figures, reference is made to the following set of elements:
10. gas turbine engine
11. intake
12. propulsive fan
13. intermediate pressure compressor
14. high pressure compressor
15. combustion equipment
16. high pressure turbine
17. intermediate pressure turbine
18. low pressure turbine
19. exhaust nozzle
20. rotor disc
21. rotor row
22. stator row
23. blades
24. blade platforms
25A. blade shanks
25B. blade attachments
26. vanes
27. vane platforms
28. seal carrier
29. seal land
30. disc cob
31. disc web
32. disc rim
33. lock plates
34. bucket grooves
40. front stator well
41. rear stator well
43. heat shield cooling flow passage
44. turbine internal cavity
45. cooling feed slots
46. disc rim front cavity
50. front disc drive arm
51. rear disc drive arm
52. front disc connecting flange
53. rear disc connecting flange
60. heat shield
61. heat shield connecting flange
62. nut and bolt combinations
63. knife edge members
70. main engine gas path
71. disc cooling flow
73. front disc hot gas ingestion
74. front disc rim sealing outflow
75. bucket groove cooling flow
76. heat shield rim leakage
77. labyrinth seal leakage
78. rear disc hot gas ingestion
79. rear disc rim sealing outflow
80. bucket groove flow restrictors
81. heat shield rim gap
82. heat shield flow restrictors
84. front heat shield spigot
85. front disc spigot
86. rear heat shield spigot
87. rear disc spigot
89. rear heat shield spigot recess

### DETAILED DESCRIPTION OF THE INVENTION

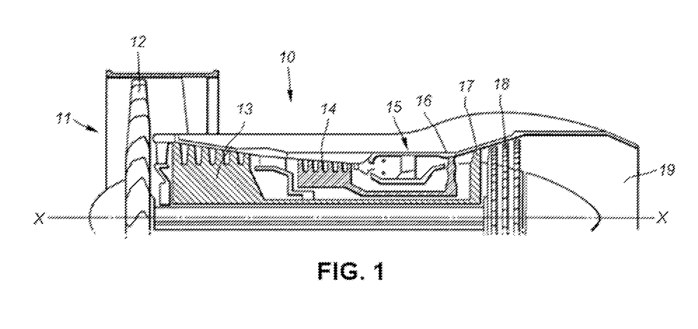

FIG. 1 is a view of a gas turbine engine generally indicated at 10 and comprises, in axial flow series, an air intake 11, a propulsive fan 12, an intermediate pressure compressor 13, a high pressure compressor 14, combustion equipment 15, a high pressure turbine 16, an intermediate pressure turbine 17, a low pressure turbine 18 and an exhaust nozzle 19.

The gas turbine engine 10 works in a conventional manner so that air entering the intake 11 is accelerated by the fan 12 which produces two air flows: a first air flow into the intermediate pressure compressor 13 and a second air flow which provides propulsive thrust. The intermediate pressure compressor compresses the air flow directed into it before delivering that air to the high pressure compressor 14 where further compression takes place.

The compressed air exhausted from the high pressure compressor 14 is directed into the combustion equipment 15 where it is mixed with fuel and the mixture combusted. The resultant hot combustion products then expand through, and thereby drive, the high, intermediate and low pressure turbines 16, 17 and 18 before being exhausted through the nozzle 19 to provide additional propulsive thrust. The high, intermediate and low pressure turbines, 16, 17 and 18 respectively, drive the high and intermediate pressure compressors 14 and 13, and the fan 12 by suitable interconnecting shafts.

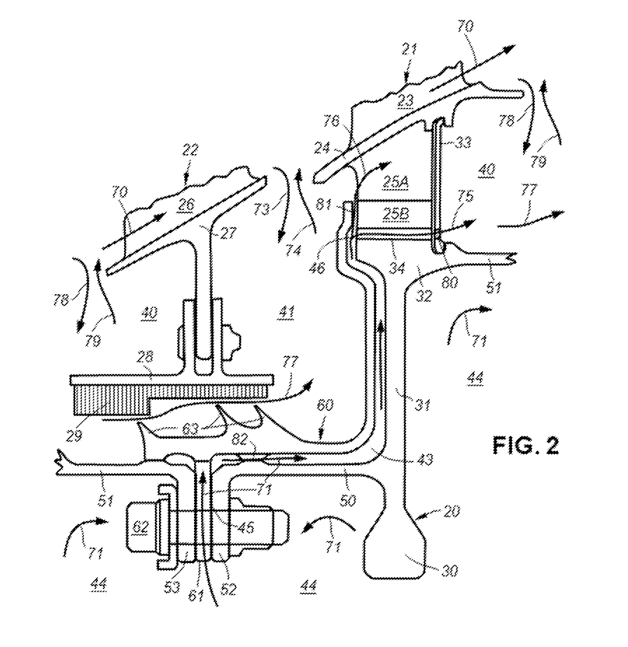

FIG. 2 is an enlarged schematic view of the low pressure turbine 18 shown in FIG. 1, which includes one intermediate stage comprising a stator row 22 and a rotor row 21.

The rotor row 21 includes a plurality of blades 23 extending radially outwardly from circumferentially extending blade platforms 24 and connecting to a circumferentially extending rotor disc 20 at blade attachments 25B of typical fir-tree or dove-tail shaped style. Blade platforms 24 are connected in their root to blade attachments 25B through radially extending circumferentially discontinuous blade shanks 25A.

The stator row 22 includes a plurality of vanes 26 extending radially outwardly from circumferentially extending vane platforms 27. A circumferentially extending seal carrier 28 is attached to vane platforms 27 by nut and bolt combinations. A circumferentially extending seal land 29, formed of an abradable material, typically of honeycomb type, is attached to the seal carrier 28.

The rotor disc 20 includes a disc cob 30 in the region of the bore of the disc, a disc rim 32 and a disc web 31 connecting the cob and the rim sections. The rotor disc 20 includes a front disc drive arm 50 which extends axially forward from the disc web 31 and a rear disc drive arm 51 which extends axially rearward from the disc rim 32. A radially inwardly extending front disc connecting flange 52 and a rear disc connecting flange 53 are located at the edge of the front disc drive arm 50 and the rear disc drive arm 51 respectively. FIG. 2 shows the rear disc drive arm 51 partially for the rotor row shown, the remaining part being shown from the preceding rotor row in the turbine. Likewise, the rear disc connecting flange is shown from the previous rotor row.

A circumferentially extending rotating heat shield 60 includes an inwardly radially extending heat shield connecting flange 61 in its front section which can be attached, by nut and bolt combinations 62, intermediate adjacent the front disc connecting flange 52 and the rear disc connecting flange 53 of the disc from the previous turbine stage. At least one knife edge members 63 extend outwardly and circumferentially about the front connecting flange section of the heat shield 60 and is axially and radially oriented to form a labyrinth seal with the seal land 29.

The heat shield 60 extends from its front connecting flange region axially rearward and then curves to extend radially outward to surround the shape of the rotor disc 20, forming an annular heat shield cooling flow passage 43 between the heat shield inboard face and the front disc drive arm 50, disc web 31, disc rim 32 and rotor blade attachments 25B.

A plurality of lock plates 33 are mounted circumferentially aligned, each covering at least one rotor blade sections, and extend radially outwardly to engage the blade platforms 24 and radially inwardly to engage the disc rim 32. The lock plates provide axial retention of the rotor blades, restricting the axial movements of the blade platforms 24 relative to the disc rim 32, and also form a physical barrier in order to prevent leakage from a higher pressure fluid in annular rear stator well 41 upstream of the front face of rotor disc 20 to annular front stator well 40 downstream of the rear face of rotor disc 20 through the cavities formed between adjacent circumferentially discontinuous blade shanks 25A and through the gaps formed between adjacent lock plates 33.

In the embodiment shown schematically in FIG. 2, a disc cooling flow 71 from an annular turbine internal cavity 44 wets and cools the inboard faces of the rotor disc 20 before being directed to circumferentially discontinuous and radially continuous cooling feed slots 45, recessed between adjacent bolts in the scalloped heat shield connecting flange 61, which put the turbine internal cavity 44 in fluid communication with the heat shield cooling flow passage 43.

The disc cooling flow 71 flows through the heat shield cooling flow passage 43 and protects the front disc drive arm 50, disc web 31 and disc rim 32 against the hot temperature gases from labyrinth seal leakage 77 and front disc hot gas ingestion 73 from main engine gas path 70.

In the embodiment shown schematically in FIG. 2, the amount of the disc cooling flow 71 is controlled by the area of heat shield flow restrictors 82. The disc cooling flow 71 splits into two flows when it reaches disc rim front cavity 46, a heat shield rim leakage 76 through a heat shield rim gap 81 and bucket groove cooling flow 75 through bucket grooves 34.

In the turbine rim gap formed by the rear end of vane platforms 27 and the front end of blade platforms 24, an inwardly flowing front disc hot gas ingestion 73 and an outwardly flowing front disc rim sealing flow 74 concur at different circumferential positions and are induced by the circumferential aerodynamic pressure profile of the main engine gas path 70. Likewise, in the turbine rim gap formed by the rear end of blade platform 24 and the front end of vane platform 27, an inwardly flowing rear disc hot gas ingestion 78 and an outwardly flowing rear disc rim sealing flow 79 concur at different circumferential positions and are induced by the circumferential aerodynamic pressure profile of the main engine gas path 70.

Labyrinth seal leakage 77 is driven by the ratio of pressures between the upstream front stator well 40 and the downstream rear stator well 41, the pressure and temperature prevailing at the upstream front stator well 40 and the radial gap between the knife edge members 63 and the seal land 29. The net flow in the turbine rim downstream of the vane platform 27 between the inflowing front disc hot gas ingestion 73 and the outwardly flowing front disc rim sealing outflow 74 is driven by the flow balance of the labyrinth seal leakage 77 and any other leakage that could exist into or from the rear stator well 41. The net flow in the turbine rim downstream of the blade platform 24 between the inflowing rear disc hot gas ingestion 78 and the outwardly flowing rear disc rim sealing outflow 79 is driven by the flow balance of the bucket groove cooling flow 75, the labyrinth seal leakage 77 and any other leakage that could exist into or from the front stator well 40.

Small amounts of the bucket groove cooling flow 75, a large amount of the labyrinth seal leakage 77 or a combination of both effects may lead to null outwardly flowing rear disc rim sealing outflow 79 with solely rear disc hot gas ingestion 78 into the front stator well 40 which brings about an undesirable increase in temperature of the gas inside the front stator well 40.

The bucket groove cooling flow 75 is a portion of the disc cooling flow 71 that flows through the bucket grooves 34 in the disc rim 32, beneath each of the blade roots in the region of the blade attachments 25B, thereby cooling disc rim 32. The amount of the bucket groove cooling flow 75 is controlled by bucket groove flow restrictors 80 machined in the lock plates 33.

The heat shield rim leakage 76 is the remaining portion of the disc cooling flow 71 following extraction of the bucket groove cooling flow 75 and is radially exhausted through the circumferentially extending heat shield rim gap 81 formed by the radially outer edge inboard face of the heat shield 60 and the front face of the rotor disc 20 in the region of the blade attachments 25B. The area of the heat shield rim gap 81 is set at least three times larger than the area of the heat shield flow restrictors 82 and also than the area of the bucket groove flow restrictors 80 which implies the pressure in the disc rim front cavity 46 is practically the same as the pressure in the rear stator well 41 at the exit of the rim gap 81.

The amount of the disc cooling flow 71 is thus dictated by the area of the heat shield flow restrictors 82, the pressure and temperature in the upstream turbine internal cavity 44 and the pressure in the downstream disc rim front cavity 46. The bucket groove cooling flow 75 is dictated by the area of the bucket groove flow restrictors 80, the pressure and temperature in the upstream disc rim front cavity 46 and the pressure in the downstream front stator well 40.

The area of the heat shield flow restrictors 82 is set to provide a predetermined higher flow than the area of the bucket groove flow restrictors 80 considering that the pressure in the disc rim front cavity 46 is practically at the same level than the pressure in the rear stator well 41 and that the area of the heat shield flow restrictors 82 and the bucket groove flow restrictors 80 could potentially be at their worst combination of extreme values of tolerances which consists in minimum tolerance area of the heat shield flow restrictors 82 and maximum tolerance area of the bucket groove flow restrictors 80. This ensures that the heat shield rim leakage 76 always flows radially outwards, preventing that the hot temperature gas mixture from the rear stator well 41, consisting of the front disc hot gas ingestion 73 and the labyrinth seal leakage 77, flows into the heat shield cooling flow passage 43, and also ensures that the heat shield rim leakage 76 cools the rotor disc 20 front face about the rotor blade attachments 25B. Any variations in the area of the heat shield rim gap 81 due to movements of the rotor disc 20 relative to the heat shield 60, induced by thermal or mechanical loads, do not affect the disc cooling flow 71, the heat shield rim leakage 76 or the bucket groove cooling flow 75 provided that the area of the heat shield rim gap 81 is such that it maintains substantially larger than the area of the heat shield flow restrictors 82 and the area of the bucket groove flow restrictors 80 at any of the operating condition. If an insufficient area was unintendedly incurred due to a partial or complete closure in any extreme situation, the disc cooling flow 71 would tend to equal the bucket groove cooling flow 75 by altering the disc rim front cavity 46 pressure to a higher level than the pressure in the rear stator well 41 which would anyhow prevent hot gas ingestion into the disc rim front cavity 46 at any time.

Some amount of flow is always required to satisfy leakage through the blade platforms 24 to the main engine gas path 70 and leakage through the lock plates 33 to the front stator well 40. Although these leakage are typically satisfied by the labyrinth seal leakage 77 and the rear disc hot gas ingestion 78, the heat shield rim leakage 76 from the heat shield is prone to be dragged and fill the cavities between adjacent blade shanks 25A after it is radially exhausted through the heat shield rim gap 81 which contributes to cool the radially outer disc rim surface exposed to the blade shank cavity fluid conditions between adjacent blade attachments 25B.

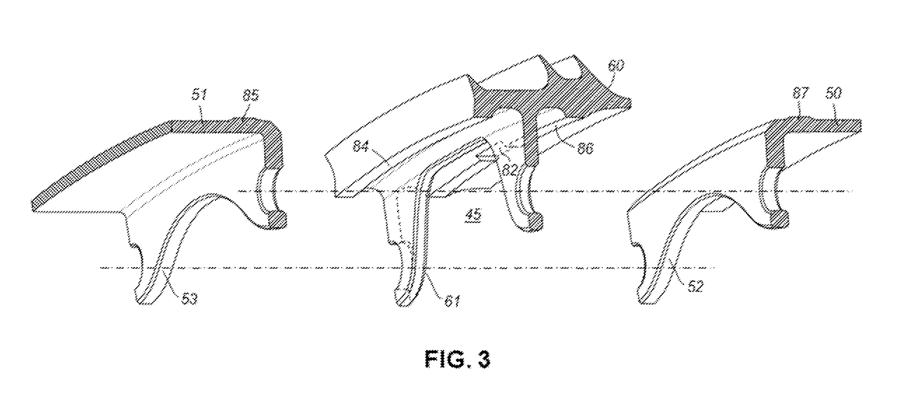

FIG. 3 is an exploded perspective view of circumferential and axial portions of the heat shield 60 and two adjacent discs, illustrating in greater detail the preferred embodiment shown in FIG. 2 in the region of the disc cooling feed. The disc cooling flow 71 is fed through cooling feed slots 45, consisting in non-restrictive to flow large area recessions in the heat shield connecting flange 61 axially bounded by the front disc connecting flange 52 and the rear disc connecting flange 53, and then passes through the heat shield flow restrictors 82, consisting in a set of axial slots circumferentially distributed along a circumferentially extending rear heat shield spigot 86 sitting on a circumferentially extending rear disc spigot 87 in the front disc drive arm 50. Leakage from disc cooling flow 71 is prevented by a circumferentially extending front heat shield spigot 84 sitting on a circumferentially extending front disc spigot 85 in the rear disc drive arm 51.

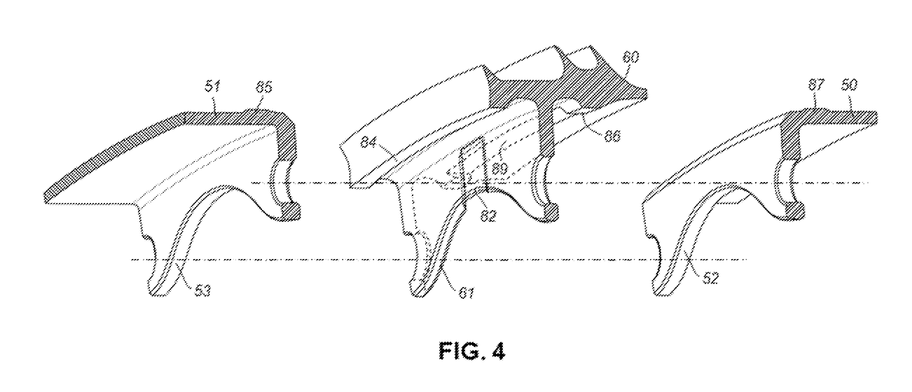

FIG. 4 is an exploded perspective view of circumferential and axial portions of the heat shield 60 and two adjacent discs, illustrating in greater detail an alternative embodiment to the embodiment shown in FIG. 3 in the region of the disc cooling feed. The disc cooling flow 71 is fed through the heat shield flow restrictors 82, which include a set of radial slots circumferentially distributed along the rearward side of the heat shield connecting flange 61 and axially bounded by the front disc connecting flange 52, and then passes through a rear heat shield spigot recess 89, consisting in a set of non-restrictive to flow large area axial slots circumferentially distributed along a circumferentially extending rear heat shield spigot 86 sitting on a circumferentially extending rear disc spigot 87 in the front disc drive arm 50. Leakage from disc cooling flow 71 is prevented by a circumferentially extending front heat shield spigot 84 sitting on a circumferentially extending front disc spigot 85 in the rear disc drive arm 51.

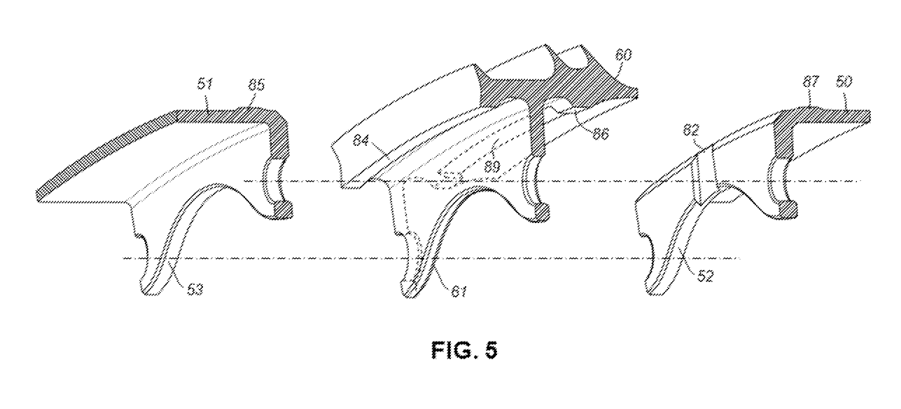

FIG. 5 is an exploded perspective view of circumferential and axial portions of the heat shield 60 and two adjacent discs, illustrating in greater detail an alternative embodiment to the embodiment shown in FIG. 3 in the region of the disc cooling feed. The disc cooling flow 71 is fed through the heat shield flow restrictors 82, which include a set of radial slots circumferentially distributed along the forward side of the front disc connecting flange 52 and axially bounded by the heat shield connecting flange 61, and then passes through a rear heat shield spigot recess 89, consisting in a set of non-restrictive to flow large area axial slots circumferentially distributed along a circumferentially extending rear heat shield spigot 86 sitting on a circumferentially extending rear disc spigot 87 in the front disc drive arm 50. Leakage from disc cooling flow 71 is prevented by a circumferentially extending front heat shield spigot 84 sitting on a circumferentially extending front disc spigot 85 in the rear disc drive arm 51.

While this invention has been described with respect to a preferred embodiment, it will be understood by those skilled in the art that various changes and modifications may be done without departing from the spirit and scope of this application as set forth in the following claims.

1. A gas turbine rotor of a gas turbine engine comprising:
a plurality of axially spaced apart adjacent rotor rows, each of said rotor rows comprising:
a rotor disc including an annular inner disc cob, an annular outer disc rim, an annular disc web connecting said cob and said rim, and blade attachments at the periphery of said rim;
a plurality of blades connected to said discs at said blade attachments;
a plurality of bucket grooves at the bottom of said blade attachments forming passages for passing cooling flow through;
annular front and rear disc drive arms extending axially forwardly and rearward from said disc respectively;
radially inwardly extending annular front and rear disc connecting flanges located at the edges of said front and rear disc drive arms respectively;
a radially inner annular turbine internal cavity extending radially inwardly of said disc, said drive arms and said disc connecting flanges;
an annular heat shield surrounding the front face of said rotor row, spaced apart from said front disc drive arm and from the front face of said disc, forming an annular heat shield cooling flow passage, and including an inwardly radially extending heat shield connecting flange attached intermediate said disc connecting flanges from said adjacent rotor rows;
first means for passing disc cooling flow from said turbine internal cavity to said heat shield cooling flow passage;
second means for restricting the area and controlling bucket groove cooling flow through said bucket grooves to predetermined values;
third means for restricting the area and controlling said disc cooling flow through said heat shield cooling flow passage, wherein said flow is predetermined to be higher than said bucket groove cooling flow;
a shield rim gap between the rim edge of said heat shield and the front face of said rotor disc of substantially larger area than those of said second means and of substantially larger area than those of said third means, wherein heat shield rim leakage through said shield rim gap is formed by said bucket groove cooling flow subtracted from said disc cooling flow;
whereby variations in the area of said shield rim gap do not affect said heat shield cooling flow or said bucket groove cooling flow and whereby said heat shield rim leakage through said shield rim gap is positively outflowing from said heat shield cooling flow passage.

2. A turbine rotor according to claim 1 wherein said blades connecting to said rotor discs are axially retained by lock plates radially engaged in said blades and said rotor discs, wherein said second means comprises orifices in said lock plates.

3. A turbine rotor according to claim 1 wherein said third means comprises a plurality of heat shield flow restrictors consisting in axial slots circumferentially distributed along a circumferentially continuous rear heat shield spigot for positively centering said heat shield relative to said front disc drive arm, and in which said first means comprises a plurality of circumferentially discontinuously distributed and radially continuous cooling feed slots, formed by radial recessions in said heat shield connecting flange and contiguous faces of said front and rear disc connecting flanges, wherein the area of said first means is set substantially larger than the area of said third means, whereby the presence of said cooling feed slots does not affect flow control of said heat shield flow restrictors.

4. A turbine rotor according to claim 1 wherein said first means and third means comprise both a plurality of heat shield flow restrictors consisting in circumferentially discontinuously distributed and radially continuous cooling feed slots, formed by radially continuous grooves in said heat shield connecting flange and the contiguous face of said rear disc connecting flange.

5. A turbine rotor according to claim 1 wherein said first means and third means are both a plurality of heat shield flow restrictors consisting in circumferentially discontinuously distributed and radially continuous cooling feed slots, formed by radially continuous grooves in said rear disc connecting flange and the contiguous face of said heat shield connecting flange.
